(19) United States
(12) Patent Application Publication
(10) Pub. No.: US 2022/0101513 A1
(43) Pub. Date: Mar. 31, 2022

(54) Method for Automatically Identifying Ring Joint of Shield Tunnel Based on Lining Structure

(71) Applicant: Shanghai Jing Hai Engineering Technology Co., Ltd., Shanghai (CN)

(72) Inventors: Zixuan Wang, Shanghai (CN); Yong Fan, Shanghai (CN); Tianxiang Liu, Shanghai (CN); Zefeng Rong, Shanghai (CN); Wangjun Liu, Shanghai (CN); Chuanqing Ni, Shanghai (CN); Hongtao Zhao, Shanghai (CN); Shixiu Wang, Shanghai (CN); Yikan He, Shanghai (CN)

(21) Appl. No.: 17/231,852

(22) Filed: Apr. 15, 2021

(30) Foreign Application Priority Data
Sep. 27, 2020 (CN) 202011028530.9

(51) Int. Cl. G06T 7/00; G06K 9/46

(52) U.S. Cl. CPC G06T 7/0004; G06K 9/4604; G06T 2207/30108; G06T 2207/10028; G06K 9/4642

(57) ABSTRACT

The present disclosure provides a method for automatically identifying a ring joint of a shield tunnel based on a lining structure. The method includes the following steps: S1: acquiring a three-dimensional (3D) point cloud of a shield tunnel through a mobile scanning system: S2: generating an orthographic projection image of an inner wall of the tunnel: S3: identifving a feature of a bolt hole; S4: extracting a longitudinal joint of the shield tunnel: S5: generating a prior structural template ring; and S6: extracting a transverse joint of the shield tunnel. The present disclosure has the following advantages. Starting from the features of the lining structure of the shield tunnel, the present disclosure selects a bolt hole with a strong structural feature, takes the structural feature of the bolt hole as an identification feature, and indirectly extracts joint information of straight and staggered joints tunnel.

### TECHNICAL FIELD

The present disclosure relates to the technical field of shield tunnel measurement, in particular to a method for automatically identifying a ring joint of a shield tunnel based on a lining structure.

### BACKGROUND

In recent years, with the rapid development of China's urban rail transit industry, the number and length of subway tunnels have increased sharply. The subway has become the most important commuting tool in the city, accompanied by a large number of subway tunnel safety monitoring and maintenance work. Shield tunnels are widely used in the construction of subway projects due to their safety, environmental friendliness and fast speed. The most notable feature of shield tunnels is the large number of joints. The total length of the joints of a 1 km long single-O-tube shield tunnel is more than 20 times the length of the tunnel itself. The joint position of the shield tunnel is often the weak point of the assembled tunnel, and the transverse and longitudinal joints of the segments are important structural features of the tunnel ring assembly.

The tunnel mileage positioning and ring segmentation depend on the accurate identification and extraction of the joint information. The extraction of the joint information is a necessary prerequisite for the completion of the calculation of the tunnel segment misalignment, the convergence of the full cross-section and the generation of the building information model (BIM).

Patent 201410726695.1 discloses a method for extracting a tunnel misalignment based on a three-dimensional (3D) scanning technology. This method manually acquires tunnel joint information through a laser scanning image, which is inefficient.

Patent 201811566725.1 discloses a method for automatically identifying a joint position of a segment based on a shield tunnel image. This method needs to construct a training set and a test set, and has a large amount of image data for processing. It is cumbersome to operate, and is susceptible to interference from linear auxiliary structures in the tunnel.

### SUMMARY

In order to overcome the above-mentioned shortcomings of the prior art, an objective of the present disclosure is to provide a method for automatically identifying a ring joint of a shield tunnel based on a lining structure. This method acquires a three-dimensional (3D) point cloud of a shield tunnel through a mobile scanning system, automatically identifies a bolt hole with a more obvious feature in a lining structure of the shield tunnel according to a structural feature of the shield tunnel, and indirectly extracts positions of transverse and longitudinal joints of the shield tunnel. The method can be widely used for automatic extraction of tunnel ring joints such as straight and staggered joints, and has the advantages of high efficiency, high precision and strong engineering practicability.

To achieve the above objective, the present disclosure provides a method for automatically identifying a ring joint of a shield tunnel based on a lining structure, including the following steps:

S1: acquiring a 3D point cloud of a shield tunnel through a mobile scanning system;

S2: generating an orthographic projection image of an inner wall of the tunnel;

S3: identifying a feature of a bolt hole;

S4: extracting a longitudinal joint of the shield tunnel;

S5: generating a prior structural template ring; and

S6: extracting a transverse joint of the shield tunnel.

Further, in step S2, a cylindrical projection model is used to perform orthographic projection of the shield tunnel to generate an orthographic image of the inner wall of the tunnel, which is used for manual prior selection of a joint and verification of a joint identification result.

Further, step S3 includes the following sub-steps:

S31: selecting a bolt hole region in a tunnel image; sampling along a tunnel mileage; calculating a distance from a corresponding point to the center of a cross-section fitting ellipse; selecting a maximum distance from a same cross-section sampling point set as a current cross-section sampling distance to compose a sampling point set G, so as to eliminate an impact of the obstruction of an auxiliary facility;

S32: taking a design width t_w and a depth t_d of a bolt hole as thresholds to perform a clustering segmentation algorithm on points in the sampling point set G, and identifying all t clusters to form a cluster centroid point set J;

S33: calculating a mean k of all identified cluster centroids in a sliding window with a width of 6; taking points with a distance less than k in the window as tunnel wall points J_2 and points with a distance greater than k as bolt hole points J_1; composing all J_1 into a bolt hole point set H, where the point set J includes two types of points, namely bolt hole cluster points J_1 and tunnel wall points J_2.

Further, step S4 includes: composing all theoretical joint mileage positions into 1; traversing in the bolt hole point set H to select a point Hᵢ; traversing in l to find a point lᵢ closest to Hᵢ; putting Hi into a point set H_{left} if Hᵢ<lᵢ; putting Hᵢ into a point set H_{right} if Hᵢ>lᵢ, and taking a closest pair of points pₗ and pᵣ from H_{left}t and H_{right}, to obtain a current longitudinal joint position pₕ of the shield tunnel:

$${p}_{h} = \frac{{p}_{l} + {p}_{r}}{2} .$$

Further, step S5 includes the following sub-steps:

S51: manually selecting joint positions of 1 to 3 rings as prior position information according to an actual situation of the tunnel, and composing joint positions of an i-th ring into a point set Oᵢ;

S52: extracting a bolt hole point set Hᵢ in the i-th ring through the algorithm in step S3; traversing bolt holes in Hᵢ, and finding a joint closest to a current bolt hole in the point set Oᵢ; storing a current joint-bolt hole positional relationship index h-oi into a positional relationship index set HOᵢ; and

S53: taking a union of the HOᵢ of all rings to obtain an overall prior structural template ring set HO.

Further, in step S6, since the ring i with a transverse joint to be identified in an interval has the same assembling method as the structural template ring in S5, it has the same “joint-bolt hole” correspondence, and it only has a rotation angle θ of 0° to 360° around a tunnel axis with the structural template ring. The identified bolt hole set Hᵢ of the to-be-identified ring i is a subset of the bolt hole set HO of the structural template ring. After a correct rotation angle θ is determined, correct matching of the bolt holes can be achieved. This step includes: rotating the to-be-identified ring i by a rotation angle θ of 0° to 360°; extracting a bolt hole point set Hᵢ of the to-be-identified ring i by the algorithm in step S3; traversing the bolt hole set in the structural template ring HO; finding, by matching, bolt holes with a smallest azimuth angle difference in the structural template ring HO corresponding to each bolt hole in Hᵢ; calculating an average angle difference δ under a current rotation angle θ; adding the δ under all values of the θ to an average angle difference set φ; selecting a smallest average angle difference in the set φ, and obtaining a corresponding rotation angle θₘᵢₙ; rotating the to-be-identified ring i by θₘᵢₙ; traversing in the prior structural template ring HO to find a template bolt hole that is closest to each bolt hole in Hᵢ, and directly obtaining a corresponding transverse joint position; taking a mean as a final transverse joint position p_z if there is a repeated joint position.

By adopting the above-mentioned technical solution, the present disclosure has the following advantages. Starting from the features of the lining structure of the shield tunnel, the present disclosure selects a bolt hole with a strong structural feature, takes the structural feature of the bolt hole as an identification feature, and indirectly extracts joint information. The present disclosure avoids the impacts of the obstruction of tunnel inner wall scanning and the interference of an auxiliary facility, and has high precision and strong robustness. The present disclosure identifies straight and staggered joints of the tunnel through a prior structural template ring, which has a good identification effect, simple operation and strong versatility, and is suitable for practical engineering applications.

### BRIEF DESCRIPTION OF THE DRAWINGS

FIG. 1 is a flowchart of a method according to the present disclosure.

FIG. 2 shows a structural feature according to an embodiment of the present disclosure.

FIG. 3 shows identification of a longitudinal joint according to an embodiment of the present disclosure.

FIG. 4 shows generation of a template ring according to an embodiment of the present disclosure.

FIG. 5 shows a transverse joint matching curve according to an embodiment of the present disclosure.

FIG. 6 shows segmentation of cross-section point segments according to an embodiment of the present disclosure.

### DETAILED DESCRIPTION

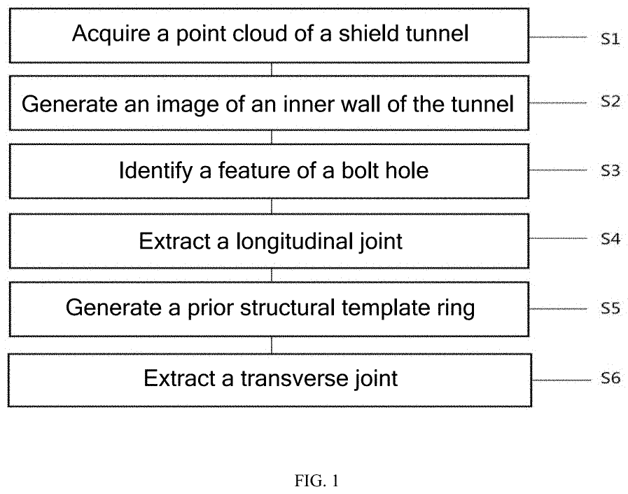

The present disclosure is described in further detail with reference to the preferred embodiments and accompanying drawings (FIGS. 1 to 6) of the present disclosure.

FIG. 1 is a flowchart of a method according to the present disclosure. The method includes the following steps:

S1: Acquire a three-dimensional (3D) point cloud of a shield tunnel through a mobile scanning system.

S2: Generate an orthographic projection image of an inner wall of the tunnel.

S3: Identify a feature of a bolt hole.

S4: Extract a longitudinal joint of the shield tunnel.

S5: Generate a prior structural template ring.

S6: Extract a transverse joint of the shield tunnel.

Further, in step S2, a cylindrical projection model is used to perform orthographic projection of the shield tunnel to generate an orthographic image of the inner wall of the tunnel, which is used for manual prior selection of a joint and verification of a joint identification result.

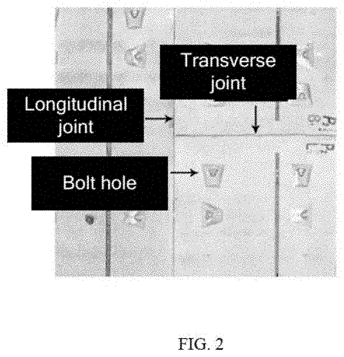

FIG. 2 shows a feature of a bolt hole that needs to be identified and transverse and longitudinal joints that need to be extracted in the present disclosure.

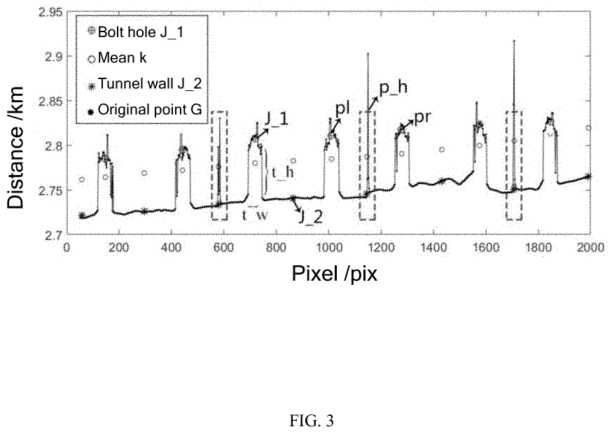

Step S3 is described in detail with reference to parameters shown in FIG. 3, and includes the following sub-steps:

S31: Select a bolt hole region in a tunnel image; sample along a tunnel mileage; calculate a distance from a corresponding point to the center of a cross-section fitting ellipse; select a maximum distance from a same cross-section sampling point set as a current cross-section sampling distance to compose a sampling point set G, which is a curve composed of original points in FIG. 3, so as to eliminate an impact of the obstruction of an auxiliary facility.

S32: Take a design width t_w and a depth t_d of a bolt hole as thresholds to perform a clustering segmentation algorithm on points in the sampling point set G, and identify all t clusters to form a cluster centroid point set J.

S33: Calculate a mean k of all identified cluster centroids in a sliding window with a width of 6; take points with a distance less than k in the window as tunnel wall points J_2 and points with a distance greater than k as bolt hole points J_1; compose all J_1 into a bolt hole point set H. As shown in FIG. 3, the point set J includes two types of points, namely bolt hole cluster points J_1 and tunnel wall points J_2.

Step S4 is described in detail with reference to parameters shown in FIG. 3. It includes: compose all theoretical joint mileage positions into l; traverse in the bolt hole point set H to select a point Hᵢ; traverse in 1 to find a point lᵢ closest to Hᵢ; put Hᵢ into a point set H_{left} if Hᵢ<lᵢ; put Hᵢ into a point set H_{right} if Hᵢ>lᵢ, and take a closest pair of points pₗ and pᵣ from H_{left} and H_{right} (as shown in FIG. 3), to obtain a current longitudinal joint position pₕ of the shield tunnel:

$${p}_{h} = \frac{{p}_{l} + {p}_{r}}{2}$$

(indicated in the dashed box in FIG. 3)

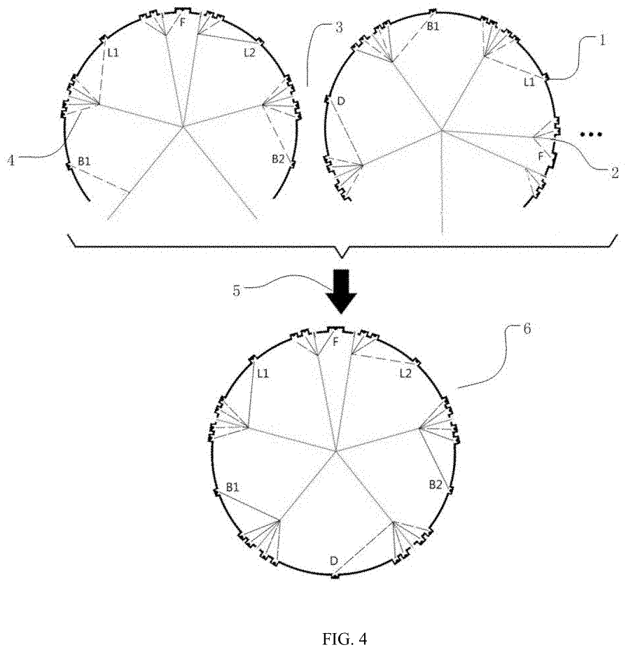

Step S5 is described in detail with reference to parameters shown in FIG. 4. The reference numerals 1 to 6 in FIG. 4 are respectively as follows: 1. Bolt hole, 2. Transverse joint, 3. Prior joint selection, 4. Joint-bolt hole correspondence, 5. Prior joint union, 6. Prior structural template ring. This step specifically includes the following sub-steps:

S51: Select joint positions of two rings as prior position information (as shown in “3. Prior joint selection” in FIG. 4), and compose joint positions of an i-th ring into a point set Oᵢ.

S52: Extract a bolt hole (“1. Bolt hole” in FIG. 4) in the i-th ring through the algorithm in step S3 to compose a point set Hᵢ; traverse bolt holes in Hᵢ, and find a joint (“2. Transverse joint” in FIG. 4) closest to a current bolt hole in the point set Oᵢ; store a current joint-bolt hole positional relationship index h-oi (“4. Joint-bolt hole correspondence” in FIG. 4) into a positional relationship index set HOᵢ.

S53: Take a union of the HOᵢ of all rings (“5. Prior joint union” shown in FIG. 4) to obtain an overall prior structural template ring set HO (“6. Prior structural template ring” shown in FIG. 4).

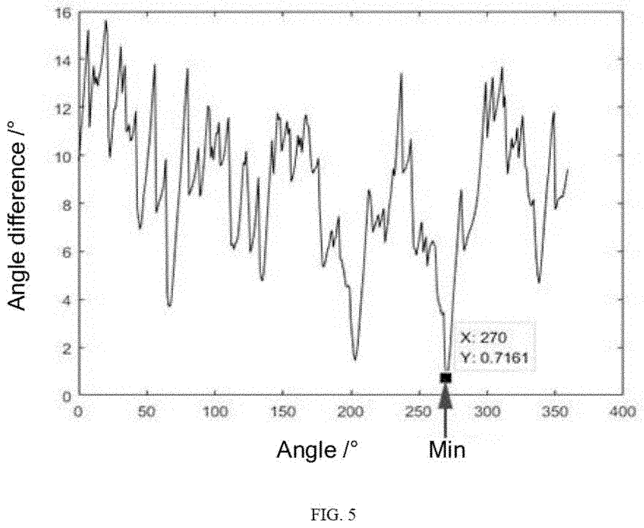

Step S6 is described with reference to FIG. 5. In this embodiment, this step includes: rotate a to-be-identified ring i by a rotation angle θ of 0° to 360°; extract a bolt hole point set Hᵢ of the to-be-identified ring i by the algorithm in step S3; traverse the bolt hole set in the structural template ring HO; find, by matching, bolt holes with a smallest azimuth angle difference in the structural template ring HO corresponding to each bolt hole in Hᵢ; calculate an average angle difference δ under a current rotation angle θ; draw a curve of the average angle difference with the rotation angle (as shown in FIG. 5); add the δ under all values of the θ to an average angle difference set φ; select a smallest average angle difference in the set φ, and obtain a corresponding rotation angle θₘᵢₙ (indicated by “Min” in FIG. 5); finally, rotate the to-be-identified ring i by θₘᵢₙ; traverse in the prior structural template ring HO to find a template bolt hole that is closest to each bolt hole in Hᵢ, and directly obtain a corresponding transverse joint position; take a mean as a final transverse joint position p_z if there is a repeated joint position.

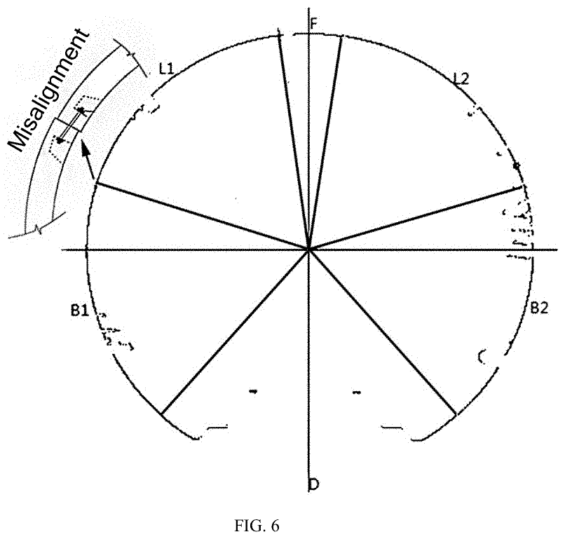

Under the premise of accurate identification of the positions of the transverse and longitudinal joints, the point cloud of the tunnel ring is divided into multiple segment point clouds (as shown in FIG. 6), and an origin of a cross-section coordinate system is the center of an ellipse for fitting a cross-section point cloud. Each segment can be regarded as an arc-shaped rigid body. In order to eliminate noise and misalignment calculations, the point cloud of each segment is fitted with a least squares circle against gross error, to obtain the center (a,b), radius r and fitting accuracy a of the fitting circle of each segment.

Misalignment refers to an uneven deformation between adjacent segments of the lining ring. The intra-ring misalignment and the inter-ring misalignment are calculated by calculating the difference in a space distance between the points on the segments i and j on both sides of the joint. Therefore, it is necessary to calculate the coordinates of the point p on the arc of the segment when the azimuth angle θ is given in the cross-section coordinate system:

xₚ=r*sin(θ)+a

yₚ=r*cos(θ)+b

The misalignment between two adjacent segments is a distance between two points:

δᵢⱼ=∥pᵢ−pⱼ∥

The calculation accuracy of the misalignment can be obtained by the circle fitting accuracy of the corresponding segment:

σᵢⱼ=\sqrt{σᵢ²+σⱼ²}

The intra-ring misalignment is calculated by adjacent segments in the ring, and the inter-ring misalignment is calculated by adjacent segments between the rings. Because there are multiple scan lines in a single ring and the fitting accuracy of different scan lines is different, the calculation accuracy of the misalignment is also different. Therefore, the scan lines in the same ring can be sampled multiple times to calculate the amount and accuracy of the misalignment respectively, and the misalignment value with the highest accuracy is selected as the final misalignment calculation result.

What is claimed is:

1. A method for automatically identifying a ring joint of a shield tunnel based on a lining structure, comprising the following steps:
S1: acquiring a three-dimensional (3D) point cloud of a shield tunnel through a mobile scanning system;
S2: generating an orthographic projection image of an inner wall of the tunnel;
S3: identifying a feature of a bolt hole;
S4: extracting a longitudinal joint of the shield tunnel;
S5: generating a prior structural template ring; and
S6: extracting a transverse joint of the shield tunnel.

2. The method for automatically identifying a ring joint of a shield tunnel based on a lining structure according to claim 1, wherein in step S1, the point cloud of the shield tunnel is acquired by a mobile scanning system, and the point cloud comprises 3D coordinate position information and intensity information.

3. The method for automatically identifying a ring joint of a shield tunnel based on a lining structure according to claim 1, wherein in step S2, a cylindrical projection model is used to perform orthographic projection of the shield tunnel to generate an orthographic image of the inner wall of the tunnel.

4. The method for automatically identifying a ring joint of a shield tunnel based on a lining structure according to claim 1, wherein step S3 comprises the following sub-steps:
S31: selecting a bolt hole region in a tunnel image; sampling along a tunnel mileage;
calculating a distance from a corresponding point to the center of a cross-section fitting ellipse; selecting a maximum distance from a same cross-section sampling point set as a current cross-section sampling distance to compose a sampling point set G, so as to eliminate an impact of the obstruction of an auxiliary facility;
S32: taking a design width t_w and a depth t_d of a bolt hole as thresholds to perform a clustering segmentation algorithm on points in the sampling point set G, and identifying all t clusters to form a cluster centroid point set J; and
S33: calculating a mean k of all identified cluster centroids in a sliding window with a width of 6; taking points with a distance less than k in the window as tunnel wall points J_2 and points with a distance greater than k as bolt hole points J_1; composing all J_1 into a bolt hole point set H, wherein the point set J comprises two types of points, namely bolt hole cluster points J_1 and tunnel wall points J_2.

5. The method for automatically identifying a ring joint of a shield tunnel based on a lining structure according to claim 1, wherein, step S4 comprises: composing all theoretical joint mileage positions into l; traversing in the bolt hole point set H to select a point Hᵢ; traversing in l to find a point lᵢ closest to Hᵢ; putting Hᵢ into a point set H_{left} if Hᵢ<lᵢ; putting Hᵢ into a point set right if Hᵢ>lᵢ, and taking a closest pair of points pₗ and pᵣ from H_{left}t and H_{right}, to obtain a current longitudinal joint position pₕ of the shield tunnel:
$${p}_{h} = \frac{{p}_{l} + {p}_{r}}{2} .$$

6. The method for automatically identifying a ring joint of a shield tunnel based on a lining structure according to claim 1, wherein step S5 comprises the following sub-steps:
S51: manually selecting joint positions of 1 to 3 rings as prior position information according to an actual situation of the tunnel, and comprising joint positions of an i-th ring into a point set Oᵢ;
S52: extracting a bolt hole point set Hᵢ in the i-th ring through the algorithm in step S3: traversing bolt holes in Hᵢ, and finding a joint closest to a current bolt hole in the point set
Oᵢ: storing a current joint-bolt hole positional relationship index h-oi into a positional relationship index set HOᵢ; and
S53: taking a union of the HOᵢ of all rings to obtain an overall prior structural template ring set HO.

7. The method for automatically identifying a ring joint of a shield tunnel based on a lining structure according to claim 1, wherein step S6 comprises:
rotating a to-be-identified ring i by a rotation angle θ of 0° to 360°: extracting a bolt hole point set Hᵢ of the to-be-identified ring i by the algorithm in step S3: traversing the bolt hole set in the structural template ring HO: finding, by matching, bolt holes with a smallest azimuth angle difference in the structural template ring HO corresponding to each bolt hole in Hᵢ: calculating an average angle difference δ under a current rotation angle θ: adding the δ under all values of the θ to an average angle difference set ω; and selecting a smallest average angle difference in the set ω, and obtaining a corresponding rotation angle θₘᵢₙ; rotating the to-be-identified ring i by θₘᵢₙ; traversing in the prior structural template ring HO to find a template bolt hole that is closest to each bolt hole in Hᵢ, and directly obtaining a corresponding transverse joint position: taking a mean as a final transverse joint position p_z if there is a repeated joint position.
